(19) United States
(12) Patent Application Publication
(10) Pub. No.: US 2005/0134872 A1
(43) Pub. Date: Jun. 23, 2005

(54) System and method for closed-loop color control of printed media

(75) Inventor: Santtu Maki, Varkaus (FI)

Correspondence Address: Anthony Miologos, Esq.;HONEYWELL INTERNATIONAL INC., Patent Services Department, 101 Columbia Road, Morristown, NJ, 07962, US

(73) Assignee: HONEYWELL INTERNATIONAL INC.

(21) Appl. No.: 11/015,858

(22) Filed: Dec. 17, 2004

Related U.S. Application Data
(60) Provisional application No. 60/530,587, filed on Dec. 18, 2003.

(51) Int. Cl. G06F 15/00

(52) U.S. Cl. 358/1.6; 358/1.9; 358/1.1

(57) ABSTRACT

There is provided a printing control system and method. The system includes a measurement unit that provides an output signal indicative of a characteristic of an image on a media formed by a printing mechanism, and a controller that responds to the output signal to modify an operation of the printing mechanism to change the characteristic of the image. The system also includes a processor that performs at least one operation based on the output signal. The method includes the steps of measuring a color density of selected images printed on a media by a print mechanism, providing at least one output signal indicative of the color density, and modifying an amount of ink used to print the images based on the output signal so as to change the color density.

### CROSS-REFERENCE TO RELATED APPLICATIONS

The present application is claiming priority of U.S. Provisional Patent Application Ser. No. 60/530,587, filed on Dec. 18, 2003, the content of which is herein incorporated by reference.

### BACKGROUND OF THE INVENTION

1. Field of the Invention

The present invention relates to printing systems, and more particularly, to color control and monitoring systems for commercial printers such as newspaper printers.

2. Description of the Related Art

Newspapers are produced predominantly according to the offset process. A plurality of paper webs are unwound from rolls, printed in the printing units and finally folded and cut. The inking can be set zone by zone in conventional inking systems. The system supplying ink to the printing plate and thereon to the web is divided into zones. For each zone there is a device controlling the amount of supplied ink. The device can be, for example, a pump (i.e., one pump per zone), one or more blades scraping a roller where the gap between the blade and the roller defines the amount of ink supplied together with the ink fountain roller speed. For each zone the opening of the pump or the size of the gap is controlled. The printer monitors the inking during the entire production and makes corrections in inking when necessary.

Current newspaper production has seen a dramatic increase in the use of color printing. Color printing requires the use of more complex printing techniques and color management that if not properly managed can result in waste and degraded quality.

Therefore, there is a need to provide both an on-line and off-line closed-loop color control management system for newspaper and commercial printing presses.

### SUMMARY OF THE INVENTION

The closed loop color control system of the present invention provides a device that measures the colors on a printed product, presents color measurements to a user with respect to the current color targets, provides for automatic control of printing devices, and provides color quality reporting. The system is useful in newspaper production, however, it can also be used to advantage in other commercial and packaging printing applications.

The system helps to keep the colors of the printed product uniform throughout the production, decreases the start-up waste as well as the run-time waste, increases production efficiency and provides quality proofs in the form of reports on product quality.

The benefits of the system and method of the present invention are a higher and more even print quality, material savings in paper and ink waste, improved press output capacity and reduced quality assurance costs.

A printing control system and method is provided for control of printing devices. The printing control system embodiment of the present invention includes a measurement unit that provides an output signal indicative of a characteristic of an image on a media formed by a printing mechanism, and a controller that responds to the output signal to modify an operation of the printing mechanism to change the characteristic of the image.

In another embodiment of the present invention, the characteristic is a color density of the image.

In another embodiment of the present invention, the output signal is indicative of a measurement of the color density. The controller modifies an amount of ink supplied by the printing mechanism for printing on the media based on a deviation between the measurement of the color density and a target color density value.

In another embodiment of the present invention, the ink is of a color selected from the group consisting of: black, cyan, magenta, yellow and any combinations thereof.

In another embodiment of the present invention, the printing mechanism is a printing press. The measurement unit is in an on-press or off-press position.

In another embodiment of the present invention, the printing control system includes a user interface in communication with the controller. The interface can display the output signal and receive one or more target characteristics.

In another embodiment of the present invention, the printing control system includes a processor that performs at least one operation based on the output signal.

In another embodiment of the present invention, the operation includes providing a record of the output signal.

In another embodiment of the present invention, the characteristic is a color density of the image. The output signal is indicative of a measurement of the color density, and the operation includes providing a record of the color density measurement.

In another embodiment of the present invention, the printing control system includes a database that receives and stores the output signal.

In another embodiment of the present invention, the operation includes providing a record of all output signals made during a selected duration of a printing task.

In another embodiment of the present invention, the printing control system includes a user interface. A user can input a target color density value, and the operation includes providing a report including data representing the color density measurement, the target color density value, and/or a deviation between the color density measurement and the target color density value.

A method embodiment of the present invention includes measuring a color density of selected images printed on a media by a print mechanism, providing at least one output signal indicative of the color density, and, based on the output signal, modifying an amount of ink used to print the images so as to change the color density.

In another embodiment of the method of the present invention, modifying the color density is based on a deviation between the color density measurement and a target color density value.

In another embodiment of the method of the present invention, the color density is measured from a preselected portion of the image.

In another embodiment of the method of the present invention, the media is paper and the preselected portion is a gray bar.

In another embodiment of the method of the present invention, the printing mechanism is a printing press, and the measurement is performed on the printing press or off of the printing press.

In another embodiment of the present invention, the method includes providing a processor with the output signal to provide a record of color density measurements made during a selected duration of a printing task.

In another embodiment of the present invention, the method includes storing the color density measurements in a database.

In another embodiment of the method of the present invention, the method includes providing at least one target color density value. The record includes data representing the color density measurement, the target color density value, a deviation between the color density measurement, and/or the target color density value.

### BRIEF DESCRIPTION OF THE DRAWINGS

FIG. 1 is a diagram of a printing device control and monitoring system.

FIG. 2 is a diagram of an on-press color control and monitoring system.

FIG. 3 is a diagram of an off-press color control and monitoring system.

FIG. 4 is an on-press measurement bar as positioned over a web.

FIG. 5 is a plan view of a measurement bar.

FIG. 6 is an on-press control system web on which pages have been printed from a doublewide, double-around printing press.

FIG. 7 is an example of a page operation display interface in density control mode.

FIG. 8 is a block diagram showing the color control software functions.

FIG. 9 is a portion of the block diagram of FIG. 8 showing the target handling function of the color control software.

FIG. 10 is a portion of the block diagram of FIG. 8 showing the status handling function of the color control software.

FIG. 11 is a portion of the block diagram of FIG. 8 showing the tuning parameter handling function of the color control software.

FIG. 12 is a portion of the block diagram of FIG. 8 showing the control function of the color control software.

FIG. 13 is a portion of the block diagram of FIG. 8 showing the output handling function of the color control software.

### DESCRIPTION OF THE INVENTION

There is provided a closed-loop color control system for use in color printing devices such as a newspaper printing press. The main components of the closed-loop color control system include on-press measurement sensors that take color measurements, such as by reading color densities, of the ink printed on a web of materials. Also included is a control system that receives color measurement information and target density information, provides a display of such information to an operator, and can modify printing components based on measured density information. The system also includes a quality reporting system that collects and displays measured and target density information for review and analysis.

A color measurement device is integrated with a control system that receives color measurement data from the color measurement device and that controls ink keys, ink rollers, and other components of a printing press. An example of a preferred control system is the Printa™ Press Control and Printa Production Management System sold by Honeywell International Inc.

In a preferred embodiment, the production operator interface is completely integrated with a standard Printa page-oriented operation. The operator uses the standard operating displays that visually present both the measured color densities and the target color densities. The displays can also provide reports by the quality reporting system. Adjustments of the color densities are performed on the very same keyboard used for controlling ink zones or are performed directly on the display using the user-friendly touch screen. No separate monitors are required for the operation. The operator is able to run the system in automatic mode or disable the automatic control to operate the system in manual mode. In automatic mode, the control system automatically adjusts the ink zones and ink fountain rollers to achieve the desired target densities, while the operator is able to simultaneously make adjustments to the target densities. When the automatic mode is disabled then the operator interacts directly with ink zones.

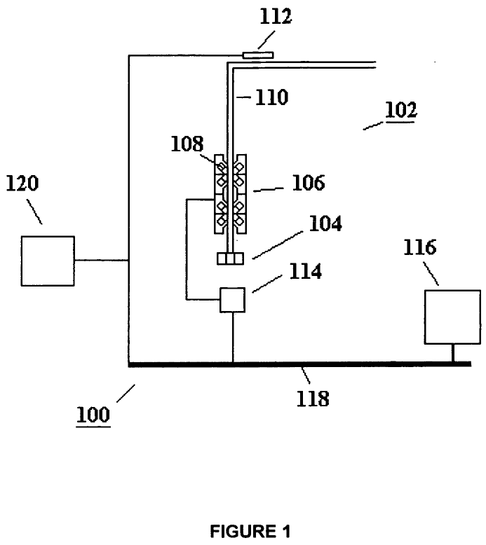

Referring to FIG. 1, a printer apparatus includes a printing mechanism 102 and a control system 100 of the present invention. Printing mechanism 102 which, for example, may be a printing press, includes a reel stand 104, a printing unit 106 including inking units 108 and a web 110. Control system 100 includes a color measurement unit 112, a printing control mechanism, i.e., controller 114, a user interface 116, and a control system bus 118. A processor 120 is also provided. Press controller 114, for example, may be the Printa Press Control System manufactured by Honeywell International Inc., and a quality reporting system.

Web 110, for example, may be paper, plastic or any other material suitable for printing. Web 110 is advanced from reel stand 104, through printing mechanism 106, and to a folding and cutting mechanism (not shown) by a web advancement device (not shown). Printing unit 106, in one example, is configured to print with various color inks, such as black, cyan, magenta, and yellow.

Color measurement unit 112 takes measurement data based on characteristics of one or more images printed on web 110 or a portion of web 110, such as color density measurements, and sends measurement data in the form of one or more output signals to controller 114 via control system bus 118. An interface (not shown) is provided to facilitate transmission of the output signal, and performs functions such as analog/digital conversion and signal shaping. The interface may be, for example, a PMD-controller. Controller 114 receives the output signal from measurement unit 112.

Controller 114 receives input, such as preselected or preferred, i.e., “target”, measurement parameters, from user interface 116, and modifies printing unit 106 based on a deviation between actual measurement data and target measurement parameters. In one embodiment, the output signal carrying actual measurement data is a measure of color density of the image, and controller 114 modifies an amount of ink supplied by printing mechanism 106 for printing on web 110 based on a deviation between the density measurement and the target color density value. The target color density is a value to which the color density measurement is compared to determine the deviation between the color density measurement and the target color density value. An error signal is generated based on the deviation to correct the amount of ink provided by printing unit 106.

User interface 116, such as a control desk, is in communication with controller 114 via bus 118. User interface 116 may include components such as a processor, memory, a screen and various inputs such as a keyboard, mouse or a touchscreen. User interface 116 allows a user to select image characteristics such as color density, and input preselected or preferred, i.e. target, image characteristics. Such target characteristics may be entered prior to commencement of a printing task, and new target characteristics may be added during the printing task.

System 100 also retains measurement data during the printing process for presentation to a user during and/or after the printing process. Processor 120 performs at least one operation in response to receiving the output signal of measurement unit 112. Processor 120 keeps a record of measurement data represented by the output signals. Processor 120 can provide real time measurement data or a report of part or a whole of a printing task, i.e. a printing run, for evaluation and quality control. In another embodiment, processor 120 may be incorporated with controller 114 or user interface 116.

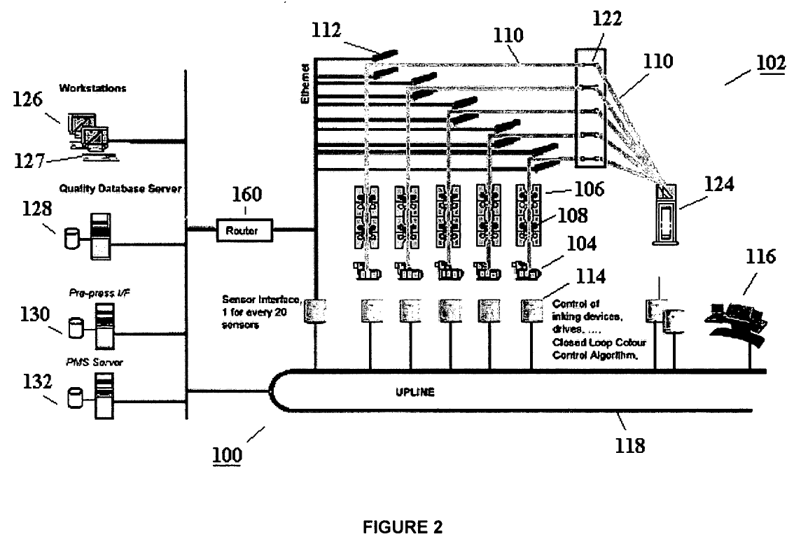

FIG. 2 shows another embodiment of control system 100 of FIG. 1, having on-press measurement units 112 and including multiple printing units 106 and additional control system features. Multiple controllers 114 are connected to control system bus 118. Controllers 114 are each in communication with one of printing units 106 for printing on webs 110, and in communication with user interface 116, such as one or more control desks. The printing press also includes turning bars 122 and folding/cutting mechanism 124.

Also shown in FIG. 2 are additional features of the system of FIG. 1 for use in any control system. These features include one or more optional workstations 126, quality database server 128, pre-press interface 130, and a production management server, i.e., a PMS server 132 that is in communication with control system 100 via bus 118. A router 134 delivers measurement information to devices such as one or more workstations 126 or a quality database server 128.

Workstations 126 are used, for example, for production planning, production monitoring and reporting. A pre-press interface 130 is used for pre-setting printing area density profiles for ink keys.

Upon activation, on-press measurement units 112 perform a search for measurement marks, such as gray bars, measure the color densities of the measurement marks, and provide the measure of color density data to press control system 100. Measurement units 112 may provide an output signal that is converted by controller 114 or another device into density data, or may derive the density data and transmit the density data to controller 114.

Press control system 100 performs numerous functions. Press control system 100 configures measurement units 112 and press 102 at the start of the production run for color density data collection. Press control system 100 also provides control software to adjust ink keys and ink fountain rollers (“ink rollers”) (not shown) of printing devices 106, provides input/output operation (I/O) for user and/or operator interface 116, and provides data to a quality reporting system.

The quality reporting system may be implemented in any of the computing devices that communicate with bus 118. These computing devices include workstations 126, database server 128, pre-press interface 130, PMS server 132, user interface 116 as well as a remote computing device that communicates with control system 100 by a network. These computing devices, when implemented as the quality reporting system, each include processor 120 and an associated memory. By way of example for the present description, quality reporting system is implemented herein as a workstation 127.

Quality reporting system 127 retrieves data representing actual and target image characteristics, such as actual measured color density and target color density, from quality database server 128 for presentation to a user, either during a printing task or after a printing task. The data may be presented in various forms to provide a user with desired quality information or specific quality reports.

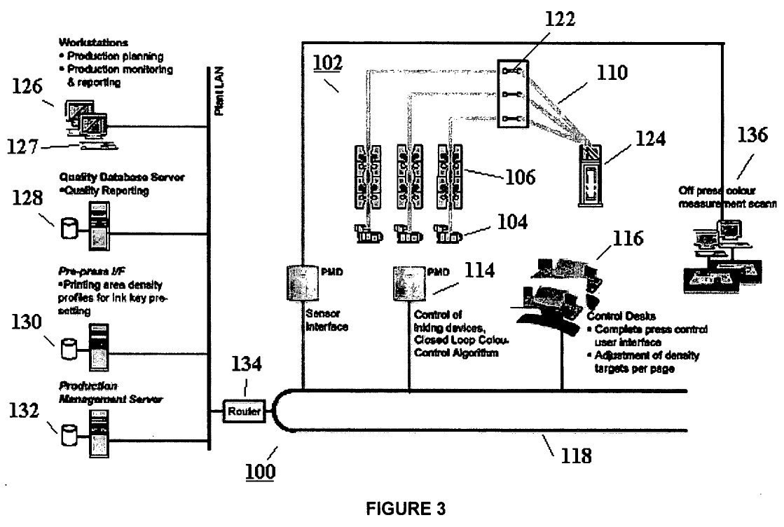

FIG. 3 illustrates another alternative embodiment of control system 100 that has off-press measurement units 112 (not shown) that are integrated into a color measurement scanner 136.

Color measurement scanner 136 is located off of printing press 102 and is used to read the color densities of images on web 110. Printed pages are transferred to scanner 136 after they are taken off of press 102. Measurement unit 112 in scanner 136 retrieves color measurement data and sends the data to controller 114 via bus 118. Color measurement data may also be sent to workstations 126 or other components via router 134. A personal computer may be included to retrieve data from off-press measurement units 112 and send the data to press controller 114. The measurement data is also provided to quality reporting system 127.

Quality reporting system 127 retrieves color density data and other data as required from press control system 100, and provides the data to computing devices such as workstations 126, quality database server 128, controller 114 and user interface 116. In another embodiment, quality reporting system 127 stores the data collected to quality database server 128, and provides the collected data, and visualization and quality tools for viewing and analyzing the data, to workstations 126.

Quality reporting system 127 can provide a user with a continuous record of actual color density measurements and density targets during the entirety of a printing run. This information can be used to evaluate a printing run and determine needed changes and/or improvements.

An exemplary method is provided for conducting the workflow of a printing device such as a press using the closed-loop color control system.

Prior to printing, during the pre-press process, halftone gray bars are inserted in a printed product layout. Plates are then produced and page data is sent to the pressroom system for calculation of printing area coverage profiles, which will be used for ink key pre-setting. Alternatively, the ink key pre-setting may be accomplished prior to or at the start of a printing run.

Imposition plans are then created for the productions. This information includes the exact positions of each page and color on the press, thereby enabling the user to concentrate on the product. This information also includes the definition of the positions and types (3-color or black) of the gray bars for each plate.

Color density measurements are performed by color density measurement unit 112 on selected images printed by printing unit 106. In a first embodiment, on-press measurement units 112 are utilized. When the printing of the selected images starts, on-press measurement units 112 immediately start measuring the color densities across the selected image printed on web 110. In a second alternative embodiment, off-press measurement scanners 136 are utilized. The off-press measurement embodiment can be used in place of the on-press measurement embodiment. In the case of off-press measurement, the frequency of the measurement is dependent on the user's manual operation. The user can immediately see the measured densities on an interface such as control desk 116.

Control system 100 can constantly calculate new values for the ink keys and/or ink fountain rollers to compensate for any detected deviation between color density measurements and target color density parameters. If the user has enabled the automatic mode, corrections are performed automatically by controller 114. During the production run, the user can adjust target color density values using the standard press control desk interface 116.

In one embodiment, control system 100 saves color density measurements and target color density values into database 128 for quality reporting and analysis purposes. The measured densities can be presented visually in real time on, for example, to workstations 126 for comparison with target densities. The data is also available for production reports to be sent to customers or for internal process improvement.

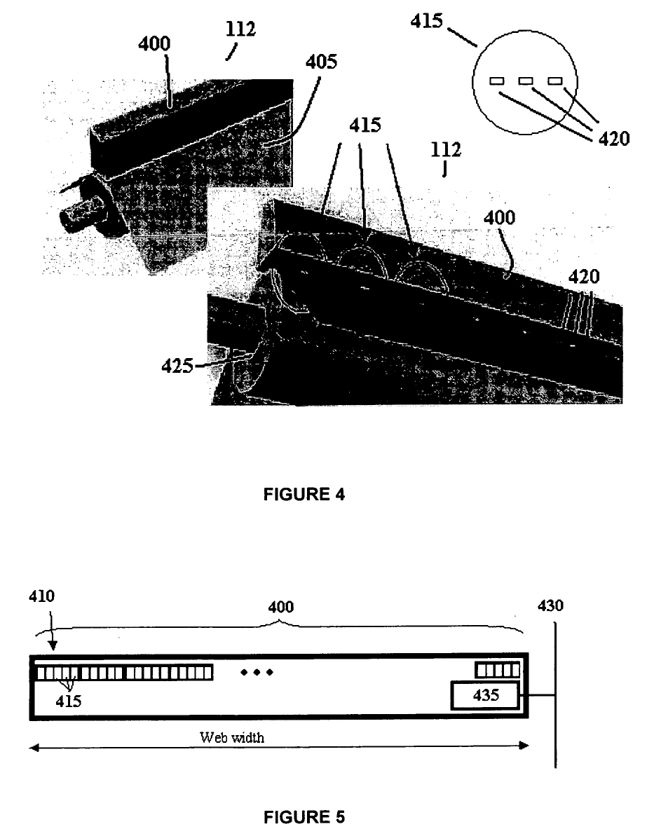

FIG. 4 and FIG. 5 illustrate an exemplary embodiment of a measurement device 112 for use with control system 100. Measurement device 112 includes color sensors for color density measurement on the press. Color may be measured, for example, by a densitometer.

As shown in FIGS. 4 and 5, measurement unit 112 includes a measurement bar 400 for each side 405 of web 110 requiring online color measurement. Measurement bar 400 includes a plurality of modules 410. In one embodiment, each module 410 contains five measurement units 415. Each measurement unit 415 includes three measurement channels 420: one measurement channel for each of the colors Cyan, Magenta and Yellow. Thus, each module 410 contains 15 measurement channels. Each measurement channel 420 contains a light-emitting diode (LED) (not shown), emitting either Red, Green, or Blue light, and a photodiode (not shown) for reflectance measurement.

The sizes of modules 410 and measurement units 415 are fixed. The number of modules 410 per measurement bar 400 is defined by the width of web 110. A typical exemplary number of modules 410 per measurement bar 400 is 11 modules.

In one embodiment, modules 410 can be configured from an external device and the data can be read by a processor 435 from measurement bar 400 and transmitted via a network, such as, an Ethernet 430.

Various measurements may be performed by each measurement unit 415. Such measurements include 1) intensity of each of C,M,Y in a 3-color gray bar, 2) color intensity in an area just prior to or after a 3-color gray bar, 3) black intensity of a 1-color gray bar, 4) color intensity in an area just prior to or after a 1-color gray bar, and 5) color intensity in a plate gap (area between pages, which should be plain paper).

Measurement bar 400 also includes an interface (not shown) to synchronize pulses, for synchronization of a printing cylinder 425. As cylinder 425 rotates, measurement modules 410 receive pulses that indicate the angle of cylinder 425. In one embodiment, there are a minimum of 2,000 pulses per cylinder revolution. In addition, one pulse is provided per revolution of cylinder 425 for reference. An exemplary power supply (not shown) is 220V.

Measurement unit 112 takes color measurements from selected images on each page of a printed web 110. In a preferred embodiment, measurement unit 112 provides color density information from narrow halftone gray bars printed on each page, such as in a newspaper printing press. In additional embodiments, other printed portions of a page can be used as a reference to control color density. In the case of a newspaper printing press, two gray bars are typically used. A first type of gray bar is a 3-color Cyan, Magenta, Yellow (CMY) neutral gray bar, and second type of gray bar is a single gray bar for measuring black color. The narrow gray bars are hidden in the newspaper layout.

Typical gray bar compositions as halftone percentages are described below. An exemplary three color gray bar includes a Cyan halftone percentage of 30%, a Magenta halftone percentage of 22%, and a Yellow halftone percentage of 22%. An exemplary halftone percentage of black in a single color gray bar is 30%

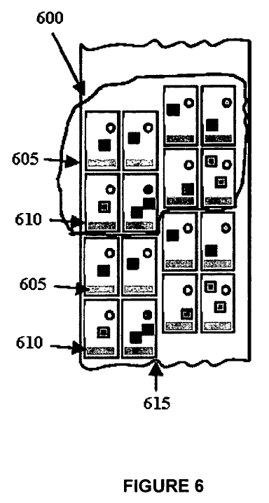

FIG. 6 shows gray bars on a product's pages on a doublewide, double-around press. In this example, a plurality of page areas 600 each contain one of a 3-color gray bar 605 or a 1-color gray bar 610.

During one cylinder revolution, two of pages 600 (either the same or different pages depending on the production mode) are printed on a web 615. Content 620 represents page content. All pages 600 contain a gray bar 605 or 610 for color measurement. Every other page in the machine direction contains 3-color gray bar 605 and every other alternate page contains 1 color gray bar 610.

In a single or double width, single around newspaper printing process, both types of gray bars would be found on the same page.

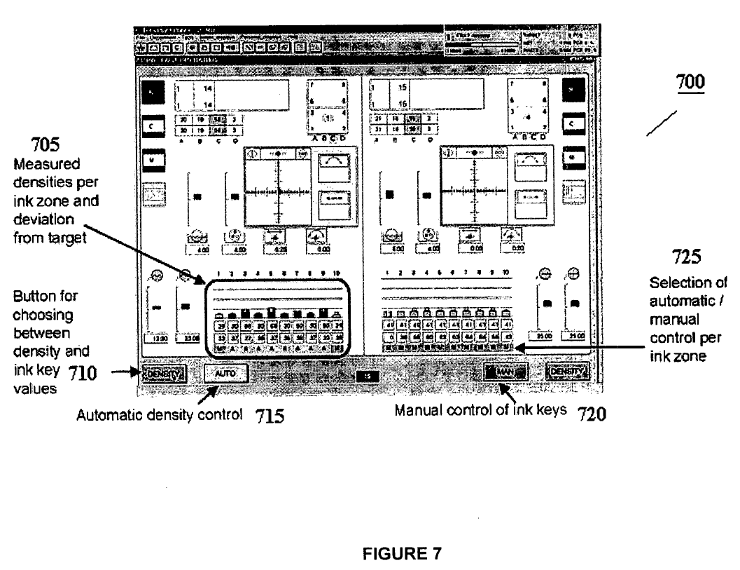

FIG. 7 is a representation of an example of a page operation display 700 in the density control mode, as may be displayed, for example, in user interface 116. Display region 705 provides a visual representation of the measured color densities for each of printing zones 1-10 on a selected page on a web. Printing zones 1-10 each correspond to an ink key. The number or printing zones can vary between different printing presses. Region 705 also illustrates each zone's deviation from a target density. Bufton 710 allows a user to choose between color density values or ink key values, i.e., settings for the amount of ink flowing to the ink fountain rollers. Buttons 715 and 720 allow the user to switch between automatic and manual control of ink keys. Bar 725 denotes manual (“M”) control of ink keys.

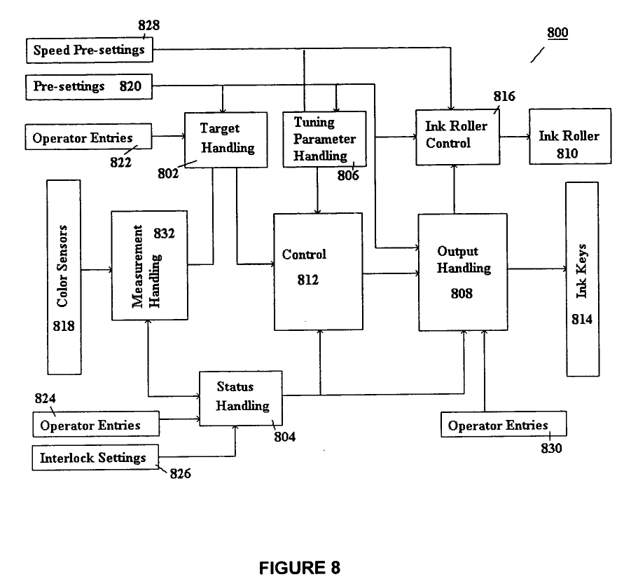

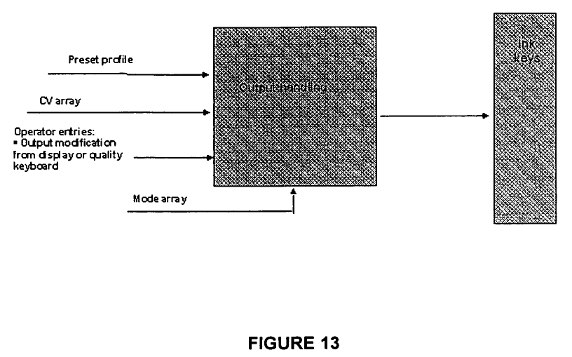

FIGS. 8-13 illustrate a Color Control Block Diagram of an exemplary embodiment of software 800 that is utilized to receive density measurements and control ink keys and rollers.

Color control software 800 controls the ink rollers and ink keys of a printing press in response to various data input including sensor status, density measurements and tuning parameters for inking devices, which are provided to a control function that controls the output of the ink rollers and ink keys. These functions, achieved through a control function in software 800, are: 1) Target density handling 802, 2) Status handling 804 receives information on status of sensors, 3) Tuning parameter handling 806, 4) Output handling 808, and 5) Ink roller control 810.

A control function 812 receives three general types of information. Target density handling function 802 receives input of actual ink density measurements and target densities, and provides control function 812 with data regarding the deviation of the actual densities from the target densities. Status handling function 804 allows an operator to set ink key modes and relays that information to control function 812 and the user displays (not shown). Tuning parameter handling function 806 calculates and sets desired tuning parameters for the ink keys 814, rollers 810 and other components, and relays that information to control function 812.

Control function 812 calculates a correction value (“CV”) array from the received data and provides the CV array to output handling function 808, which controls the output of ink keys 814 and also directs ink roller control 816 to modify the speed of ink roller 810 in response to ink key values. Ink key values refer to the settings of the amount of ink flowing to ink fountain rollers 810.

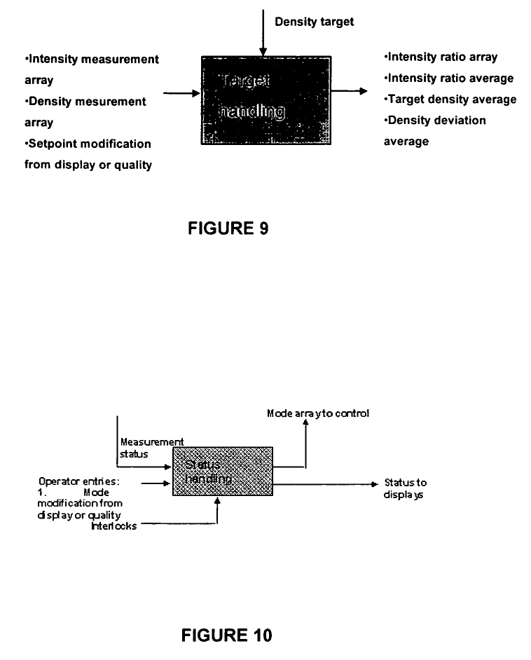

Referring to FIG. 9, target handling function 802 receives information in the form of a density and intensity measurement arrays/profiles from measurement handling function 832, which receives density measurements from color sensors 818, and also receives the pre-set density set point/target profile, i.e. pre-settings 820. In the case of measurement bar 400 as described in FIGS. 4-5, the array contains all measurements from one measurement bar 400. In one embodiment, the measurement values are running averages with a varying length (e.g. last two values, last four values). Target handling function 802 may also receive ink key set point modification instructions or target density updates from an operator represented by operator entries 822.

Target handling function 802 calculates the Intensity ratio array/profile that is used in controlling inking devices 810 and 814. An intensity ratio average is calculated, and is used in conjunction with information regarding sensor status and tuning parameters for ink roller control. The Intensity ratio is defined by the following formulas:
Intensity ratio=Intensity measurement/Target intensity
Target Intensity=10^{Target density}.

Target handling function 802 also calculates the density deviation, using target density average, density deviation array, density average, and density deviation average. Color density is equal to log(intensity for light reflected from paper/color intensity), and density deviation is equal to the difference between the measured density and the target density. This function is also responsible for updating target intensities/densities.

Referring to FIG. 10, status handling function 804 provides for control of inking devices in response to the status of printing press components or measurement sensors 818, and also provides status information to a user interface (not shown). Status handling function 804 receives ink key mode information, measurement status, and interlock information. The function can control various ink key modes. An operator can set the mode of ink keys or inking zones, represented by operator entries 824, via interfaces such as density information or page operation displays. For example, in Manual mode, the user changes the settings of ink keys 814 and ink fountain rollers 810 manually; control system 100 takes color measurements but does not control the inking devices. In Automatic mode, the control system measures and adjusts the settings of ink keys 814 and ink fountain rollers 810 automatically. The user can change the color measurement targets. Control of all ink keys 814 may be automatically interlocked, i.e, disabled, if the press speed drops below a minimum preset value, or while the press speed is ramped up or down. Control of an ink key 814 may also be interlocked based on interlock settings 826 and/or if measurement status is bad, i.e if one or more sensors 818 malfunction or fail. Status handling function 804 provides mode array information to Control function 812, and status information to the page operation displays.

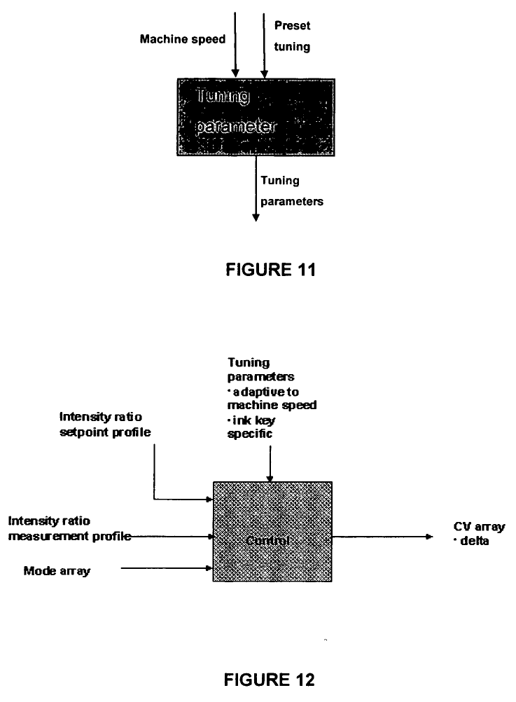

Referring to FIG. 11, tuning parameter handling function 806 provides information regarding the pre-set tuning parameters 820 of ink keys 814, ink rollers 810, and other aspects of the press settings to control function 812. Control function 812 can adjust its operation based on the supplied parameters 820. The function includes calculation of the tuning parameters. A process to be controlled can be characterized by parameters such as gain, and time constants such as up/down and transfer time. Ink and paper type can be taken in account in pre-setting tuning parameters. Ink key specific tuning parameters may be among the pre-set parameters. An additional tuning parameter, a tightness parameter, is used to dampen the control when control deviation is small. The tightness parameter defines how ‘tight’ or fast the controller is. The smaller the value the slower the controller.

Referring to FIG. 12, control function 812 provides printing device based control, i.e. each printing device has its own control. One control function 812 can control several printing devices. Measurement data is correlated to control function 812 using preset ink-key configuration data, so that measurements can be associated with the correct ink keys 814.

Control function 812 receives the intensity ratio array/profile, intensity ratio measurement, mode information, and tuning parameters such as machine speed and ink key parameters.

The control cycle is variable, but in one example is about five seconds. The control cycle refers to the frequency of calculation of new set points for ink keys 814 or ink fountain rollers 810. Control function 812 calculates a delta output, from which set points of each ink key 814 can be modified. Ink key set point modification is proportional to the immediately previous ink key set point.

Referring to FIG. 12, output handling function alters the ink roller and ink key control in response to the output of Control function 812. The output handling function also receives pre-set ink key profile information, and mode array information from the status handling function. Changes to ink key set points are proportional to the immediately previous ink key set point. An operator may also directly modify the the output of ink key 814, represented by operator entries 830.

In one embodiment, if the ink key set point is less than a minimum value, then the proportional set point is calculated using the minimum value. If the ink key set point change in the control cycle is bigger than a defined maximum value, then the set point change is limited to the maximum value. If an ink key preset set point is zero then the key is not used in control.

Setting an ink key set point maximum and minimum limit is an option. One common maximum value may be set for all ink keys 814. Individual minimum set point values may be set for each ink key 814. Another optional embodiment includes an ink key profile shape limiting option. In this embodiment, the preset ink key profile is kept in a memory. If this option is selected, the control system can not change an ink key set point more than defined amount from the preset profile. An ink key profile smoothing option may be employed to remove unnescessary bending in the ink key profile in the long run. In another option, first and second order bending limits can be employed to protect the ink blade from bending too heavily. The first order bending limit tells how much the ink key set point for one ink key can 814 differ from an adjacent ink key 814. The second order bending limit is the allowed set point difference sum to the left and right hand side ink keys 814.

Ink roller control function 816 controls the ink roller speed. The function receives pre-set information including speed set point information in speed pre-settings 828. Ink roller function 816 also receives an ink key profile from the output handling function.

The ink duct roller speed preferably follows a predefined speed curve. The curve specifies the duct roller speed in relation to the press speed. This curve is defined during pre-setting. The duct roller speed can be adjusted with the speed set point. Speed set point is indicated as percentage from the range defined by the duct roller curve, (0%=duct roller stopped, 100%=max. speed defined by the curve). Control system 100 can adjust the ink roller speed by changing a so-called Correction Value. The correction value is adjusted when ink roller control 816 is enabled and if a sufficient number of ink keys 814 that are in automatic mode have a set point greater than a defined maximum value or less than a defined minimum value. The ink roller correction value is increased only if the intensity ratio average is less than a defined limit and there are no ink keys 814 already closed. Respectively, the ink roller correction value is decreased only if the intensity ratio average is greater than a defined limit and there are no ink keys 814 already open.

It should be understood that various alternatives, combinations and modifications of the teachings described herein could be devised by those skilled in the art. The present invention is intended to embrace all such alternatives, modifications and variances that fall within the scope of the appended claims.

1. A printing control system comprising:
a measurement unit that provides an output signal indicative of a characteristic of an image on a media formed by a printing mechanism; and
a controller that responds to said output signal to modify an operation of said printing mechanism to change said characteristic of said image.

2. The printing control system of claim 1, wherein said characteristic is a color density of said image.

3. The printing control system of claim 2, wherein said output signal is indicative of a measurement of said color density, and wherein said controller modifies an amount of ink supplied by said printing mechanism for printing on said media based on a deviation between said measurement of said color density and a target color density value.

4. The printing control system of claim 3, wherein said ink is of a color selected from the group consisting of: black, cyan, magenta, yellow and any combinations thereof.

5. The printing control system of claim 1, wherein said printing mechanism is a printing press, and wherein said measurement unit is in a position selected from the group consisting of: on-press and off-press.

6. The printing control system of claim 1, further comprising a user interface in communication with said controller, wherein said interface can display said output signal and receive one or more target characteristics.

7. The printing control system of claim 1, further comprising a processor that performs at least one operation based on said output signal.

8. The printing control system of claim 7, wherein said operation includes providing a record of said output signal.

9. The printing control system of claim 7, wherein said characteristic is a color density of said image, and wherein said output signal is indicative of a measurement of said color density, and wherein said operation includes providing a record of said color density measurement.

10. The printing control system of claim 7, further comprising a database that receives and stores said output signal.

11. The color control management system of claim 7, wherein said operation includes providing a record of all output signals made during a selected duration of a printing task.

12. The printing control system of claim 9, further comprising a user interface, wherein a user can input a target color density value, and wherein said operation comprises providing a report including data selected from at least one member of the group consisting of: said color density measurement, said target color density value, a deviation between said color density measurement and said target color density value, and any combination thereof.

13. A method for color control management which comprises:
measuring a color density of selected images printed on a media by a print mechanism;
providing at least one output signal indicative of said color density; and
based on said output signal, modifying an amount of ink used to print said images so as to change said color density.

14. The method of claim 13, wherein modifying said color density is based on a deviation between said color density measurement and a target color density value.

15. The method of claim 13, wherein said color density is measured from a preselected portion of said image.

16. The method of claim 15, wherein said media is paper and wherein said preselected portion is a gray bar.

17. The method of claim 13, wherein said printing mechanism is a printing press, and wherein said measurement is performed at a location selected from the group consisting of: on said printing press and off of said printing press.

18. The method of claim 13, further comprising providing a processor with said output signal to provide a record of color density measurements made during a selected duration of a printing task.

19. The method of claim 18, further comprising storing said color density measurements in a database.

20. The method of claim 18, further comprising providing at least one target color density value, wherein said record includes data selected from the group consisting of: said color density measurement, said target color density value, a deviation between said color density measurement and said target color density value, and any combinations thereof.
